(19) United States
(12) Patent Application Publication
(10) Pub. No.: US 2021/0007386 A1
(43) Pub. Date: Jan. 14, 2021

(54) CLEANING EQUIPMENT FOR FOOD PRODUCTION

(71) Applicant: ZHEJIANG GONGSHANG UNIVERSITY JINHUA FOOD INDUSTRIALIZATION RESEARCH INSTITUTE CO., LTD., Jinhua (CN)

(72) Inventor: Guanglei SONG, Jinhua (CN)

(21) Appl. No.: 16/796,590

(22) Filed: Feb. 20, 2020

(30) Foreign Application Priority Data
Jul. 11, 2019 (CN) 201910624272.1

(51) Int. Cl. A23N 12/00; B08B 1/00; B08B 5/02; B08B 3/02

(52) U.S. Cl. CPC A23N 12/005; B08B 3/022; B08B 5/023; B08B 1/001

(57) ABSTRACT

A cleaning equipment for food production. The cleaning equipment includes a cleaning platform and a cleaning device arranged on the cleaning platform, where the cleaning platform is provided therein with a cleaning tank; the cleaning tank is provided with a plurality of air spraying tubes at the bottom; the cleaning device includes a first pulley rotatably arranged on the cleaning platform, a first driving member driving the first pulley to rotate, a second pulley rotatably arranged on the cleaning platform, a crawler belt wound between the first pulley and the second pulley and a plurality of wipers evenly arranged on the crawler belt; a cleaning cavity for accommodating food is formed between two adjacent wipers; when the crawler belt rotates, a wiper moving to the cleaning cavity drives the food to move forward in the cleaning tank; the crawler belt is provided with a clamping member for fixing the wiper.

### TECHNICAL FIELD

The present invention relates to the technical field of food processing, and in particular, to cleaning equipment for food production.

### BACKGROUND

With the continuous development of society and the continuous progress of science and technology, people's living standards are constantly improving. Fruits are an essential food for people. They are rich in vitamins and are an essential source of vitamins for human body. However, with the improvement of living standards, environmental pollution has become increasingly serious. Therefore, it is necessary to clean fruits before eating and during fruit processing. During fruit processing, fruits are brought into water for cleaning. Although this can achieve a cleaning purpose, there are still problems as follows:

Traditional fruit cleaning machines immerse fruits in a sink or spray them with a sprinkler head. The cleaning process cannot be as careful as rubbing by hands alone. The cleaning effect of unified immersion cleaning is not ideal, and certain impurities or pesticides will be left, which will cause certain harm to people who eat the fruits.

In a cleaning tank, fruits in the front are pushed forward by those in the back one by one. As the fruits collide with each other, the fruit surface is easy to bump and crush, causing the skin to rupture. In addition, the cleaning water will penetrate into the pulp of the fruits to cause pollution and seriously affect the quality of the fruits.

### SUMMARY

An objective of the present invention is to provide cleaning equipment for food production, to solve the above problems in the prior art.

An objective of the present invention is achieved by the following technical solution: cleaning equipment for food production, including a cleaning platform and a cleaning device arranged on the cleaning platform, where the cleaning platform is provided therein with a cleaning tank; the cleaning tank is provided with a plurality of air spraying tubes at the bottom; the cleaning device includes a first pulley rotatably arranged on the cleaning platform, a first driving member driving the first pulley to rotate, a second pulley rotatably arranged on the cleaning platform, a crawler belt wound between the first pulley and the second pulley and a plurality of wipers evenly arranged on the crawler belt; a cleaning cavity for accommodating food is formed between two adjacent wipers; when the crawler belt rotates, a wiper moving to the cleaning cavity drives the food to move forward in the cleaning tank; the crawler belt is provided with a clamping member for fixing the wiper.

The working principle of the present invention is as follows: When a fruit needs to be cleaned, the cleaning tank is filled with clean tap water, and the fruit to be cleaned is put into the cleaning tank. The air spraying tubes spray air into the cleaning tank. The fruit rolls in the cleaning tank under the action of an airflow, and some large dirt falls off a surface of the fruit under the effect of the rolling. At the same time, the first driving member is started to drive the first pulley to rotate. The first pulley drives the second pulley to rotate through the crawler belt. The crawler belt rotates and drives a wiper on an end surface of the crawler belt to rotate. When the wiper is rotated to a lower end surface of the crawler belt, the wiper drives the fruit in the cleaning tank to move forward. When the wiper drives the fruit forward, the fruit rolls on a surface of the wiper, so that the wiper cleans the surface of the fruit.

According to the present invention, when the fruit is located in the cleaning tank, the fruit is preliminarily cleaned through the plurality of air spraying tubes. The wipers are arranged to move the fruit in the cleaning tank forward when the wipers are driven by the crawler belt to rotate. Compared with a traditional method of pushing fruits forward one by one, the cleaning equipment avoids bumping and crushing on a surface of a fruit due to collision between fruits in the front and in the back. Therefore, the fruit has a good appearance after cleaning, which is convenient for later sales. The wipers wipe the surface of the fruit to achieve the fine cleaning of the fruit while pushing the fruit forward. Compared with traditional immersion cleaning, the cleaning equipment cleans better and more thorough to avoid harm to human health. The cleaning equipment performs coarse and fine cleaning simultaneously, which greatly shortens the fruit cleaning time and reduces the cost of an enterprise. When a wiper needs to be cleaned, the wiper is simply detached from the clamping member and replaced with a clean one. Therefore, the cleaning equipment cleans the fruit continuously compared to traditional equipment needing to be shut down for cleaning. Besides, a wiper is replaced alone without replacing all the wipers, and the wiper is reusable by cleaning, which greatly reduces the cost of the enterprise. When the wipers drive the fruit in the cleaning tank forward, the crawler belt is always located directly above the cleaning cavity to press down the fruit in the cleaning cavity to wholly immerse in water, thereby further improving the cleaning of the fruit.

The wiper is elastic.

The clamping member includes a plurality of fixing posts arranged along a circumferential direction of the crawler belt, a magnetic part embedded in the fixing post and a clamping post attracting to the magnetic part; the fixing post is arranged on a side of the crawler belt; an end of the wiper is sandwiched between the clamping post and the fixing post.

The clamping post is provided with a pull buckle on an upper end.

The crawler belt is evenly provided with a plurality of air holes; a cavity is formed between upper and lower layers of the crawler belt; the cavity is provided therein with an air spraying assembly for spraying air outward.

The air spraying assembly includes an air spraying box arranged in the cavity and a second driving member for supplying air into the air spraying box; top and bottom layers of the air spraying box are provided with a plurality of vent grooves; air in the air spraying box is sprayed from the vent grooves.

The cleaning equipment further includes a water removing device for wiping off water on a surface of a fruit.

The water removing device includes a water removing platform, a plurality of rollers sequentially arranged in the water removing platform and a plurality of air spraying tubes arranged above the water removing platform; an air spraying groove is arranged on a lower side of the air spraying tube for the air to spray out; the air spraying groove is opened toward a direction between two adjacent rollers.

The roller is sleeved with a water absorbing layer.

The water absorbing layer is a sponge, and an abutting plate abutting against the water absorbing layer is arranged at the bottom of the water removing platform. When the abutting plate and the water absorbing layer abut, the water absorbing layer is in a compressed state.

Compared with the prior art, the present invention wipes the surface of the fruit through the wiper to achieve fine cleaning of the fruit while pushing the fruit forward, and has the advantage of better and more thorough cleaning.

### BRIEF DESCRIPTION OF THE DRAWINGS

FIG. 1 is a first structural diagram of the present invention.

FIG. 2 is a second structural diagram of the present invention.

FIG. 3 is a detail of A in FIG. 2.

FIG. 4 is a sectional diagram of the present invention.

FIG. 5 is a partial exploded view of a cross wheel of the present invention.

In the figure, 1, cleaning platform; 2, cleaning tank; 3, air spraying tube; 4, first pulley; 5, first driving member; 6, second pulley; 7, crawler belt; 8, wiper; 9, cleaning cavity; 10, fixing post; 11, clamping post; 12, air hole; 13, cavity; 14, air spraying box; 15, second driving member; 16, vent groove; 17, water removing platform; 18, roller 19, air spraying tube; 20, air spraying groove; 21, water absorbing layer; 22, abutting plate; 23, fixing plate; 24, air pump; 25, liquid discharge tube; 26, storage box; 261; through hole; 262, dropping channel; 27, cross wheel; 28, limiting groove; 29, limiting post; 30, return spring; 31, clamping slot; 32, convex part; 321, slider; 291, sliding groove; 33, water removing driving member; 34, pulley; 35, conveyor belt; 36, water removing air pump; 37, pillar; and 111, pull buckle.

### DETAILED DESCRIPTION

The technical solutions of the present invention are described in further detail below with reference to the specific embodiments and accompanying drawings, but the present invention is not limited thereto.

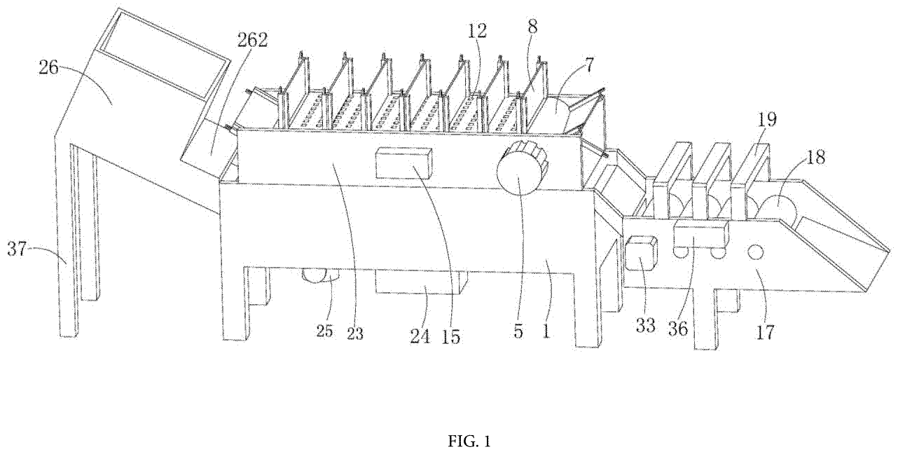

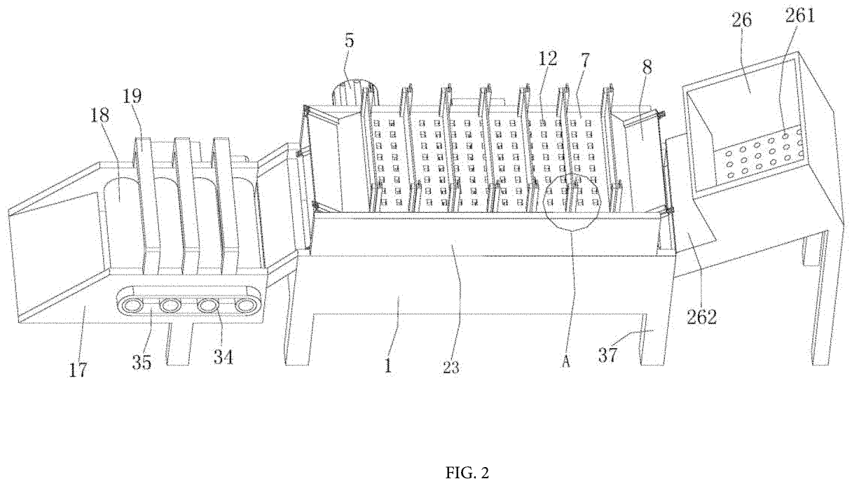

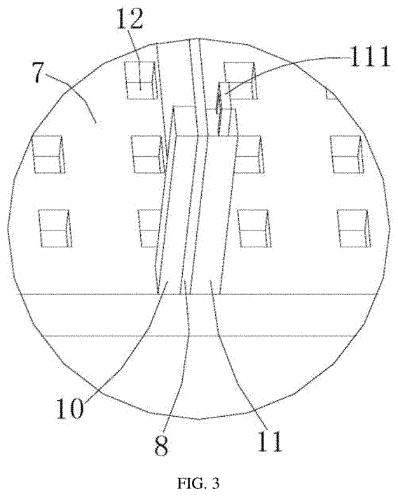

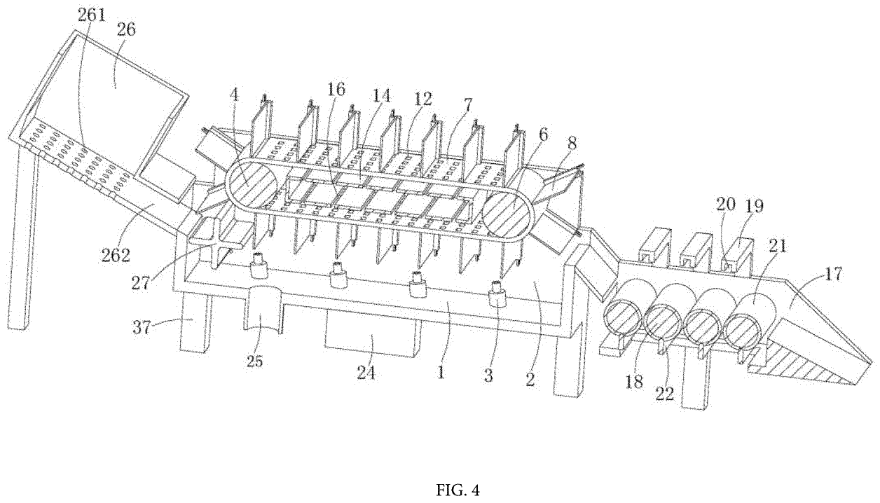

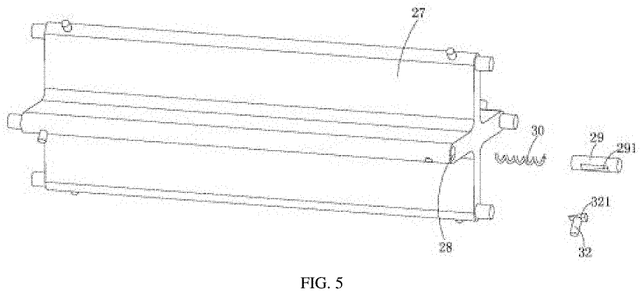

As shown in FIG. 1 to FIG. 5, cleaning equipment for food production includes a cleaning platform 1 and a cleaning device arranged on the cleaning platform 1. An upper end surface of the cleaning platform 1 is concave inward to form a cleaning tank 2. The cleaning tank 2 is evenly provided therein with a plurality of air spraying tubes 3 at the bottom. An air pump 24 is arranged at the bottom of the cleaning platform 1. The air pump 24 is a common air pump that can be purchased directly on the market. The air spraying tube 3 and the air pump 24 are connected through an air tube. The air spraying tube 3 is inclined to spray toward a wiper 8, so that when the air spraying tube 3 sprays air, a fruit and a side of the wiper 8 are brought into contact with each other. In addition, the obliquely sprayed air promotes the rolling of the fruit on a surface of the wiper 8, thereby achieving a thorough cleaning of a surface of the fruit and preventing dirt from remaining on the surface of the fruit.

Further, in order to improve a cleaning effect on the fruit, the wiper 8 is elastic. When the wiper 8 abuts against the fruit, the fruit gives the wiper 8 a certain pressure, so that the wiper 8 deforms to wrap the surface of the fruit to rub a large area of the fruit surface.

Further, in order to fix the cleaning device, two fixing plates 23 are symmetrically arranged above a side wall of the cleaning platform 1.

Further, the cleaning device includes a first pulley 4 rotatably arranged on the cleaning platform 1, a first driving member 5 driving the first pulley 4 to rotate, a second pulley 6 rotatably arranged on the cleaning platform 1, a crawler belt 7 wound between the first pulley 4 and the second pulley 6 and a plurality of wipers 8 evenly arranged outside the crawler belt 7. The first pulley 4 is movably connected between the two fixing plates 23 and is arranged at a left end thereof. The second pulley 6 is movably connected between the two fixing plates 23 and is arranged side by side to the right of the first pulley 4. The crawler belt 7 is a stainless steel crawler belt wound between the first pulley 4 and the second pulley 6. Upper and lower layers of the crawler belt 7 are separated to form a cavity 13.

Further, the crawler belt 7 is provided with a clamping member for fixing the wiper 8 so that the wiper 8 is detachable. When the wiper 8 needs to be cleaned, the wiper is detached and replaced with a new one without shutting the equipment down for a long time.

Further, the clamping member includes a plurality of fixing posts 10 protruding along a circumferential direction of the crawler belt 7, a magnetic part embedded in the fixing post 10 and a clamping post 11 attracting to the magnetic part. In the present invention, the fixing post 10 is a vertical stainless steel post welded outside the crawler belt 7 and arranged perpendicular to the crawler belt 7. The magnetic part is a magnet. The fixing post 10 is provided with a groove for the magnetic part to be inserted. The magnetic part is adhered to the groove. The fixing posts 10 are arranged on both left and right sides of the crawler belt 7 to form a circle. The clamping post 11 is a vertical post supported by a magnetic material. The clamping post 11 and the fixing post 10 are fixed by magnetic attraction between the magnetic part and the clamping post 11. When the clamping post 11 and the fixing post 10 are fixed, two ends of the wiper 8 are sandwiched between the clamping post 11 and the fixing post 10 respectively to fix the wiper 8.

Further, two adjacent wipers 8 reserve a gap to form a cleaning cavity 9 for accommodating food. When the crawler belt 7 rotates, a wiper 8 on a lower end surface of the crawler belt drives the fruit to move forward in the cleaning tank 2, avoiding collision between front and back fruits. The wiper 8 wipes the surface of the fruit while driving the fruit forward. The cleaning is more thorough than traditional immersion and spray cleaning methods.

Further, in order to facilitate the detachment of the wiper 8, the clamping post 11 is provided with a pull buckle 111 at one end of away from the crawler belt 7. The pull buckle 111 is held and lifted up to separate the clamping post 11 from the fixing post 10. In this way, the two attracted magnets are separated, and the detachment is labor-saving as a force is perpendicular to a magnetic line of an attraction surface.

Further, a plurality of air holes 12 are evenly arranged on the crawler belt 7, and an air spraying assembly for spraying air outward is arranged in the cavity 13. When the air spraying assembly works, air is sprayed from the air holes 12 on a surface of the crawler belt 7 to generate a downward force on the fruit in the cleaning tank 2. The fruit floats upward due to its buoyancy after sinking, which promotes the fruit to roll up and down while moving forward, so that the rolling of the fruit is violent, thereby improving the wiping of the wiper 8 on the fruit surface.

Further, in this embodiment, the air spraying assembly includes an air spraying box 14 arranged in the cavity 13 and a second driving member 15 for inflating the air spraying box 14. Left and right ends of the air spraying box 14 are respectively welded to an inner wall of the fixing plate 23. The second driving member 15 is a common air pump that can be purchased directly on the market. The second driving member 15 is welded outside one of the fixing plates 23, and an output shaft thereof extends through a corresponding through hole on the fixing plate 23 to reach the air spraying box 14. In this way, the second driving member 15 transports air into the air spraying box 14. Upper and lower end walls of the air spraying box 14 are provided with a plurality of vent grooves 16. The vent grooves 16 are transversely arranged at intervals along a length of the air spraying box. The air in the air spraying box 14 is sprayed from the vent groove 16, and the air sprayed from the upper end surface of the air spraying box 14 is sprayed from the air hole 12 on the upper end surface of the crawler belt 7. In this way, the crawler belt 7 is cleaned by the sprayed air, which prevents an impurity from accumulating on the crawler belt 7 and prevents the impurity from blocking the air hole 12. The air sprayed from the lower end surface of the air spraying box 14 is sprayed from the air hole 12 on the lower end surface of the crawler belt 7. The sprayed air acts on the surface of the fruit to cause the fruit to sink. The fruit floats upward due to its buoyancy after sinking. In this way, the fruit moves up and down, which promotes the rolling of the fruit, and improves the cleaning efficiency. As the vent grooves 16 are arranged on the upper and lower end walls of the air spraying box 14, the air is sprayed from the upper and lower ends. This avoids waste of air, ensures a sufficient air pressure generated by the air spraying assembly and ensures a good air spraying effect.

Further, the air holes 12 are arranged obliquely. The air holes 12 on the lower end surface of the crawler belt 7 have an air spraying direction opposite to that of the air spraying tubes 3, so that the rolling of the fruit is further promoted.

Further, in order to facilitate the discharge of a liquid in the cleaning tank 2, a liquid discharge tube 25 communicating with the cleaning tank 2 is arranged at the bottom of the cleaning platform 1. The liquid discharge tube 25 is provided with a valve for controlling flow rate and volume of the liquid.

Further, the cleaning platform 1 is provided with a storage box 26 at a left end; the storage box 26 and the cleaning platform 1 are connected by a dropping channel 262; a fruit in the storage box 26 rolls down to the cleaning tank 2 of the cleaning platform 1 through the dropping channel 262. The fruit to be cleaned is placed in the storage box 26 and automatically drops. This saves time, labor and labor cost compared with a traditional cleaning device requiring manual feeding for cleaning.

Further, the storage box 26 is provided with a plurality of through holes 261 at the bottom, so that an impurity in the storage box 26 is discharged through the through holes 261. In this way, the impurity falling off the surface of the fruit will not enter into the cleaning tank 2 together with the fruit to pollute the cleaning liquid.

Further, in order to prevent a large amount of fruits from pouring into the cleaning tank 2 from the storage box 26, the cleaning tank 2 is rotatably connected therein with a cross wheel 27. The cross wheel 27 rotates 90° clockwise to bring a part of the fruits into the cleaning tank 2. Therefore, the amount of the fruits entering into the cleaning tank 2 is controlled, which prevents excessive fruits from entering into the cleaning tank 2 to cause incomplete cleaning and ensures a good cleaning effect.

Further, four wheel arms of the cross wheel 27 are respectively provided with a limiting groove 28 on both sides far from an axis. The limiting groove 28 is provided therein with a limiting post 29 which can move back and forth. The limiting post 29 and the limiting groove 28 are connected through a return spring 30. Two ends of the return spring 30 are respectively welded to an inner wall of the limiting post 29 and the limiting groove 28. An inner wall of the cleaning tank 2 is provided with a clamping slot 31 fit with the limiting post 29. When a wheel arm rotates to a highest point, the limiting post 29 on the wheel arm is partially embedded in the clamping slot 31 under the action of the return spring 30 to fix the cross wheel 27. Meanwhile, the limiting post 29 on the other wheel arms is wholly embedded in the limiting groove 28 and the return spring 30 is in a compressed state.

Further, the limiting post 29 is provided thereon with a convex part 32 slidably fit with the limiting post. When the convex part 32 moves inward, the limiting post 29 is driven to move into the limiting groove 28. The convex part 32 passes through a corresponding through hole on the wheel arm of the cross wheel 27 to protrude and incline toward a side of the storage box 26. When the clamping post 11 rotates under the action of the crawler belt 7 to contact the convex part 32, the clamping post 11 continues to rotate and press the convex part 32. As the convex part 32 is pressed, the limiting post 29 moves into the limiting groove 28, so that the limiting post 29 is detached from the clamping slot 31 to release the cross wheel 27. Then the clamping post 11 continues to drive the cross wheel to drop a fruit. After the cross wheel 27 rotates 90°, the limiting post 29 on the next wheel arm is embedded in the clamping slot 31 to fix the cross wheel 27 again, and the next clamping post 11 arrives to complete the dropping operation again.

Further, in this embodiment, the convex part 32 is provided with a slider 321 at one end abutting against the limiting post 29; the limiting post 29 is transversely provided with a sliding groove 291 fit with the slider. When the convex part 32 is pressed, the slider at the end thereof can move along the sliding groove. As the convex part 32 cannot move transversely, the limiting post 29 moves into the limiting groove 28.

Further, the cleaning equipment includes a water removing device for removing water from a surface of a fruit. If a fruit is directly packaged without being wiped dry after cleaning, as there is still a lot of water on an outer skin of the fruit, the fruit is perishable, which will shorten the preservation time of the fruit, increase the cost and waste a resource.

Further, the water removing device includes a water removing platform 17, a plurality of rollers 18 arranged in the water removing platform 17 and a plurality of air spraying tubes 19 arranged above the water removing platform 17. The water removing platform 17 is connected to the cleaning platform 1 through an inclined rail. After being cleaned, a fruit is driven by the wiper 8 to slide from the inclined rail to the water removing platform 17. Two ends of the roller 18 are rotatably connected to a side wall of the water removing platform 17, respectively. The water removing platform 17 is connected with a water removing driving member 33 for driving the roller 18 to rotate. The water removing driving member 33 is a common motor that can be purchased directly on the market. An output shaft of the water removing driving member 33 is connected to one of the rollers through a coupler. In this embodiment, a number of the rollers 18 is set to four. The four rollers 18 are connected through a pulley 34 and a conveyor belt 35, so that when one of the rollers 18 rotates, the remaining three rollers 18 are driven to rotate simultaneously. The air spraying tube 19 is provided with an air spraying groove 20 on a lower side. The air spraying groove 20 is opened toward a gap between two adjacent rollers 18. The air in the air spraying tube 19 is sprayed toward the gap between the two rollers 18 from the air spraying groove 20. In this way, part of water droplets on the surface of the fruit are blown off from the gap between the rollers 18 to realize preliminary water removing of the fruit surface. An outer side wall of the water removing platform 17 is welded with a water removing air pump 36 for inflating the air spraying tube 19. The air spraying tube 19 is connected to the water removing air pump 36 through an air tube.

Further, the roller 18 is sleeved with a water absorbing layer 21. When the roller 18 rotates, the water absorbing layer absorbs water on the surface of the fruit. In this way, the fruit is wiped dry with a good water removing effect.

Further, in this embodiment, the water absorbing layer 21 is an elastic sponge adhered to the roller 18. The elastic sponge has excellent water absorptivity and elasticity.

Further, the water removing platform 17 is provided with an abutting plate 22 for abutting against the water absorbing layer 21 at the bottom. When the abutting plate 22 abuts against the water absorbing layer 21, the water absorbing layer 21 is partially compressed. When the roller 18 rotates, water in the water absorbing layer 21 is squeezed out under the action of the abutting plate 22, which ensures a good drying effect of the water absorbing layer 21 on the fruit. Besides, an end of the abutting plate 22 abutting against the water absorbing layer 21 is formed into an arc shape to prevent the abutting plate 22 from tearing the water absorbing layer 21.

Further, in order to facilitate the discharge of water in the water removing platform 17, the bottom of the water removing platform 17 is hollowed.

Further, in order to support the cleaning platform 1, the storage box 26 and the water removing platform 17, a plurality of pillars 37 are welded to the bottom of the cleaning platform 1, the storage box 26 and the water removing platform 17.

The specific embodiments described herein are merely intended to illustrate the spirit of the present invention. Those skilled in the art can make various modifications or supplements to the specific embodiments described or replace them in a similar manner without departing from the spirit of the present invention or the scope defined by the appended claims.

Although terms are used extensively herein, the possibility of using other terms is not excluded. The terms are only intended to describe and explain the essence of the present invention more conveniently. It is contrary to the spirit of the present invention to interpret these terms as any additional limitation.

1. Cleaning equipment for food production, comprising a cleaning platform and a cleaning device arranged on the cleaning platform, wherein the cleaning platform is provided therein with a cleaning tank; the cleaning tank is provided with a plurality of air spraying tubes at the bottom; the cleaning device comprises a first pulley rotatably arranged on the cleaning platform, a first driving member driving the first pulley to rotate, a second pulley rotatably arranged on the cleaning platform, a crawler belt wound between the first pulley and the second pulley and a plurality of wipers evenly arranged on the crawler belt; a cleaning cavity for accommodating food is formed between two adjacent wipers; when the crawler belt rotates, a wiper moving to the cleaning cavity drives the food to move forward in the cleaning tank; the crawler belt is provided with a clamping member for fixing the wiper.

2. The cleaning equipment for food production according to claim 1, wherein the wiper is elastic.

3. The cleaning equipment for food production according to claim 1, wherein the clamping member comprises a plurality of fixing posts arranged along a circumferential direction of the crawler belt, a magnetic part embedded in the fixing post and a clamping post attracting to the magnetic part; the fixing post is arranged on a side of the crawler belt; an end of the wiper is sandwiched between the clamping post and the fixing post.

4. The cleaning equipment for food production according to claim 3, wherein the clamping post is provided with a pull buckle on an upper end.

5. The cleaning equipment for food production according to claim 1, wherein the crawler belt is evenly provided with a plurality of air holes; a cavity is formed between upper and lower layers of the crawler belt; the cavity is provided therein with an air spraying assembly for spraying air outward.

6. The cleaning equipment for food production according to claim 1, wherein the air spraying assembly comprises an air spraying box arranged in the cavity and a second driving member for supplying air into the air spraying box; top and bottom layers of the air spraying box are provided with a plurality of vent grooves; air in the air spraying box is sprayed from the vent grooves.

7. The cleaning equipment for food production according to claim 1, wherein the cleaning equipment further comprises a water removing device for wiping off water on a surface of a fruit.

8. The cleaning equipment for food production according to claim 1, wherein the water removing device comprises a water removing platform, a plurality of rollers sequentially arranged in the water removing platform and a plurality of air spraying tubes arranged above the water removing platform; an air spraying groove is arranged on a lower side of the air spraying tube for the air to spray out; the air spraying groove is opened toward a direction between two adjacent rollers.

9. The cleaning equipment for food production according to claim 1, wherein the roller is sleeved with a water absorbing layer.

10. The cleaning equipment for food production according to claim 1, wherein the water absorbing layer is a sponge, and an abutting plate abutting against the water absorbing layer is arranged at the bottom of the water removing platform; when the abutting plate and the water absorbing layer abut, the water absorbing layer is in a compressed state.
